(19) United States
(12) Patent Application Publication
(10) Pub. No.: US 2009/0110797 A1
(43) Pub. Date: Apr. 30, 2009

(54) DISPERSIBLE COMPOSITIONS COMPRISING COCOA POWDER AND PROCESSES FOR PRODUCING

(76) Inventors: Thomas Gottemoller, Mt. Zion, IL (US); Steve Laning, Menomonee, WI (US); Adam Lechter, Shorewood, WI (US); Michael E. Price, Mt. Zion, IL (US)

Correspondence Address: ARCHER DANIELS MIDLAND COMPANY, 4666 FARIES PARKWAY, DECATUR, IL, 62526, US

(21) Appl. No.: 12/257,767

(22) Filed: Oct. 24, 2008

Related U.S. Application Data
(60) Provisional application No. 60/982,187, filed on Oct. 24, 2007.

(51) Int. Cl. A23L 1/236; A23G 1/50

(52) U.S. Cl. 426/548; 426/631

(57) ABSTRACT

The present teaching relates generally to cocoa products. In one embodiment, a composition comprises a sweetener, a digestion resistant soluble fiber, a cocoa powder, and a dispersing agent. In the composition, the sweetener, the digestion resistant soluble fiber, the cocoa powder and the dispersing agent are present in such amounts such that the composition disperses in liquid. Processes for producing the compositions are also disclosed.

### CROSS-REFERENCE TO RELATED APPLICATIONS

This application claims the benefit of U.S. Provisional Application No. 60/982,187, filed Oct. 24, 2007, the contents of the entirety of which are incorporated by this reference.

### TECHNICAL FIELD

The present teaching relates generally to cocoa products, compositions containing the cocoa products and processes for manufacturing such cocoa products and compositions.

### SUMMARY OF THE DISCLOSURE

In one embodiment, a composition comprises a sweetener, a digestion resistant soluble fiber, a cocoa powder, and a dispersing agent. In the composition, the sweetener, the digestion resistant soluble fiber, the cocoa powder and the dispersing agent are present in such amounts such that the composition disperses in liquid.

In another embodiment, a composition comprises an agglomerate of at least two particles selected from the group consisting of a sweetener particle, a digestion resistant soluble fiber particle, a cocoa powder particle, and combinations of any thereof. The composition further comprises a dispersing agent associated with the agglomerate.

In yet a further embodiment, a product is produced by a process that includes mixing a granule of a sweetener, a granule of a cocoa powder, and a granule of a digestion resistant soluble fiber, thus producing a blend of the granules of the sweetener, the cocoa powder and the digestion resistant soluble fiber. The process further includes mixing a dispersing agent in water and agglomerating the blend of the granules with the dispersing agent in the water.

In an additional embodiment, a process includes mixing a granule of a sweetener, a granule of a cocoa powder, and a granule of a digestion resistant soluble fiber, thus producing a blend of the granules of the sweetener, the cocoa powder and the digestion resistant soluble fiber. The process also includes suspending the blend of the granules in an air flow and spraying water on the suspended blend of the granules such that agglomerates of at least two of the granules form.

In another embodiment, a composition includes a sweetener particle, a digestion resistant soluble fiber particle, a cocoa powder particle, a calcium containing particle, and an agglomerate comprising at least two particles selected from the group consisting of the sweetener particle, the digestion resistant soluble fiber particle, the cocoa powder particle, the calcium containing particle and combinations of any thereof. The composition also includes a deoiled lecithin associated with the sweetener particle, the digestion resistant soluble fiber particle, the cocoa powder particle, the calcium containing particle, the at least one agglomerate, or combinations of any thereof.

### DESCRIPTION OF THE DRAWINGS

FIG. 1 is a table disclosing run conditions of one embodiment of an agglomeration process used in the present teaching.

FIG. 2 discloses particle size distributions of various embodiments of agglomerates produced using the processes of the present teaching.

FIG. 3 is a table disclosing run conditions of one embodiment of an agglomeration process used in the present teaching.

FIG. 4 is a picture of granules used in one embodiment of a composition of the present teaching.

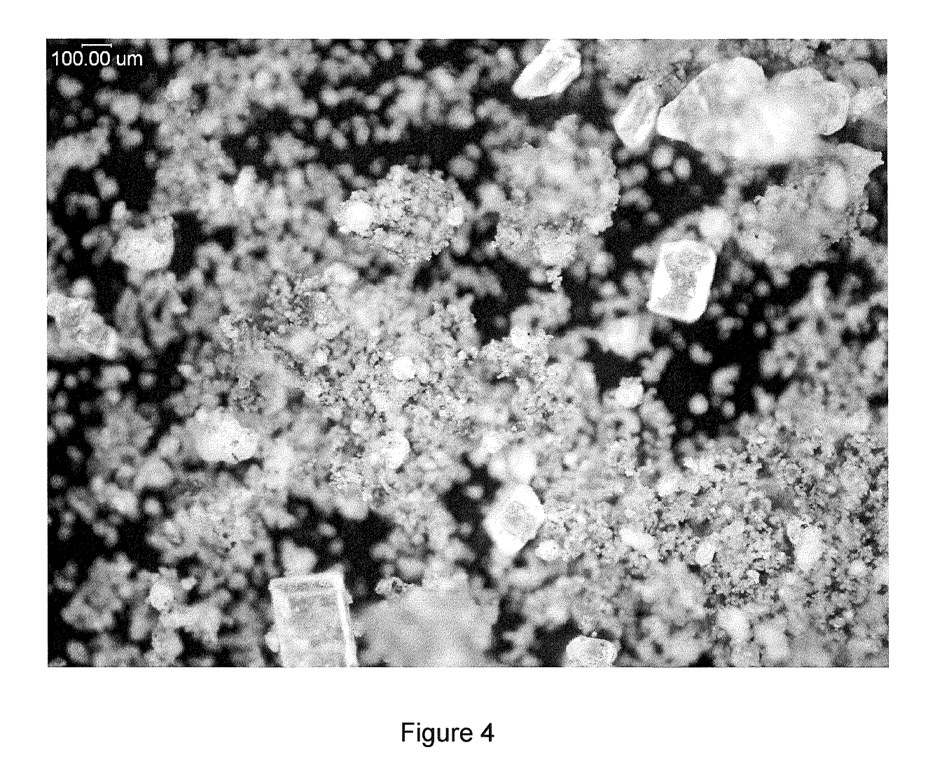

FIG. 5 is a picture of one embodiment of agglomerates produced by the present teaching.

FIG. 6 is a picture of granules used in one embodiment of a composition of the present teaching.

FIG. 7 is a picture of one embodiment of agglomerates produced by the present teaching.

FIG. 8 discloses particle size distributions of various embodiments of agglomerates produced using the processes of the present teaching.

### DETAILED DESCRIPTION

As used herein, a “tablespoon” refers to a unit of measure containing between 5 and 30 grams by mass of the material being measured. As used herein a “teaspoon” refers to a unit of measure containing between 2 and 15 grams by mass of the material being measured.

In each of its various embodiments, the present invention discloses dispersible compositions comprising cocoa powders, as well as processes for producing such dispersible compositions.

In one embodiment, the dispersible composition comprising the cocoa powder includes an agglomerate of granules. The agglomerated granules comprise at least two of particles of a sweetener particle, a digestion resistant soluble fiber particle, a cocoa powder particle, and combinations of any thereof. In certain embodiments, the agglomeration may be achieved with a spray dryer, drum dryer, tunnel vacuum belt dryer, dryer, rotary dryer, tray dryer, spray granulator or spray agglomerator.

In one embodiment, the composition may be used as an instantized, free-flowing dry cocoa beverage mix. In another embodiment, the beverage mix may have or give enhanced nutritional qualities when added to a beverage. The enhanced nutritional qualities may include, but not be limited to, being a good or excellent source of fiber, calcium or fiber and calcium depending on a specific formulation of the beverage mix.

In order to be a good source of fiber based on the Food and Drug Administration (“FDA”) guidelines, one serving of a food product should have at least 2.5 grams of fiber per serving such that 10% of the Daily Value of fiber is consumed with the one serving. To be an excellent source of fiber, one serving of the food product should have at least 5 grams of fiber such that 20% of the Daily Value of fiber is consumed with the one serving. In order to be a good source of calcium based on the Food and Drug Administration (“FDA”) guidelines, one serving of a food product should have at least 100 milligrams of calcium per serving such that 10% of the Daily Value of calcium is consumed with the one serving. To be an excellent source of calcium, one serving of the food product should have at least 200 milligrams of calcium such that 20% of the Daily Value of calcium is consumed with the one serving.

In one embodiment, the dry beverage mix may be formulated such that about two tablespoons of the dry beverage mix is added to one serving of the beverage. Thus, the two tablespoons of the dry beverage mix will provide the enhanced nutritional qualities. In various embodiments, the dry beverage mix may be added to beverages including, but not limited to, milk, water, soy milk, rice milk, coffee, tea, or any other beverage.

In another embodiment, a process for producing the dispersible composition includes agglomerating a dry powder mixture of the components of the dispersible composition. The agglomeration process improves the powder flow characteristics of the components, facilitates content uniformity, improves segregation issues, and enhances the ability of the components to disperse in a liquid. Non-agglomerated, dry components of the dispersible composition do not wet well and are difficult to disperse in a liquid. In one embodiment, the components of the dispersible composition are agglomerated with a fluid bed dryer.

In an additional embodiment, the dispersible composition of the present teaching may be placed in a container. The container may be associated with indicia capable of informing a user of the dispersible composition of the nutritional characteristics of the dispersible composition by itself and in combination with a beverage. The container may be configured and sized for use by commercial food manufacturers or for consumer use.

In various embodiments, the compositions and processes of the present teaching use various cocoa powders. Cocoa powders that may be used include, but are not limited to, DE ZAAN brand cocoa powders available from the Cocoa Division of Archer Daniels Midland Company of Milwaukee, Wis. In another embodiment, one of the cocoa powders disclosed in U.S. Provisional Patent Application 60/849,548 filed Oct. 5, 2006 and entitled “Method of Producing High-Brightness Cocoa Powder and Related Compositions,” the contents of the entirety of which is incorporated by this reference, may be used in the present teaching. In other embodiments, cocoa powders that may be used are selected from one or more of the group comprising low fat cocoa, defatted cocoa, high fat cocoa, neutralized cocoa, alkalized cocoa, highly alkalized cocoa, black cocoa, bright cocoa or any combinations thereof.

The soluble fibers that may be used in the various embodiments of the present teaching include, but are not limited to, pyrodextrins available under the brand name FIBERSOL® (available from Archer Daniels Midland Company Decatur, Ill.; FIBERSOL® is a registered trademark of Matsutani Chemical Industry Co. Ltd.) or NUTRIOSE SOLUBLE FIBER™ (available from Roquette Frères, Cedex, France). FIBERSOL-2 brand resistant maltodextrin is an off-white powder having maximum moisture of 5%, a maximum of 0.2% ash, a dextrose equivalent of 8.0-12.5, a pH of 4.0-6.0, has a water soluble dietary fiber of 90% minimum DSB, and less than 0.5% protein. Other soluble fibers that may be used include, without limitation, fructans or fructose oligosaccharides (OLIGGO-FIBER® brand inulin) and/or oligofructose (available from Cargill Health & Food Technologies, Minneapolis, Minn.), maltodextrins, polydextrose and combinations of any thereof.

In various embodiments, the sweeteners that may be used include, but are not limited to, natural or artificial sweeteners, a sweetener solution or syrup, a nutritive sweetener, fructose, crystalline fructose, sucrose, a non-nutritive sweetener, maltitol, isomalt, lactitol, xylitol, erythritol, sorbitol, mannitol, tagatose, acesulfame K, sucralose, saccharin, cyclamates, aspartame, alitame or any combinations thereof.

In other embodiments, a flavoring agent may be used in the compositions of the present teaching. Examples of flavoring agents that may be used include, but are not limited to, a vanilla flavor (e.g., natural vanillin, methyl vanillin, ethyl vanillin or any combinations thereof), banana flavor, strawberry flavor and combinations of any thereof. Other flavoring agents may be used depending on the desired use of the composition. In embodiments, a cocoa or coffee flavor may be used. In other embodiments, more than one flavoring agent may be added depending on the desired use.

In yet additional embodiments, the compositions of the present teaching may comprise a dispersing agent or emulsifier. Non-limiting examples of dispersing agents that may be used include, but are not limited to, standard lecithins, purified lecithins, complexed lecithins, modified lecithins, deoiled lecithins, acetic acid esters, citric acid esters, diacetyl tartaric acid esters of monoglycerides, distilled monoglycerides, emulsifier blends, lactic acid esters, tartaric acid esters, lecithin blends, monoglycerides, diglycerides, polyglycerol esters, polyglycerol polyricinoleates, sorbitan esters, sorbitan monostearate, ethoxylated monoglycerides, sodium stearoyl lactylates, propylene glycol monostearate, sucrose esters, fatty acid esters of sugar alcohols, calcium stearoyl lactylates, polysorbates, and combinations of any thereof. In one embodiment, the dispersing agent comprises ULTRALEC P brand lecithin which is a deoiled, granular lecithin available from Archer Daniels Midland Company of Decatur, Ill. ULTRALEC P brand lecithin comprises an ultrafiltered, deoiled soy lecithin having a minimum of 97.0% acetone insolubles, maximum moisture of 1.0%, maximum hexane insolubles of 0.05% and an effective HLB of about 7.

In further embodiments, the compositions of the present teaching may further include a calcium containing compound. Calcium containing compounds that may be used include, but are not limited to, calcium citrate, calcium lactate, calcium carbonate, calcium phosphate or any combinations thereof.

In yet other embodiments, proteins may be used in the compositions of the present teaching. Proteins that may be used include, but are not limited to: wheat protein; wheat protein isolate (i.e., any chemically or enzyme catalyzed wheat protein isolate including without limitation wheat protein isolate FP 5000, Arise 5000, and Arise 6000, each available from Midwest Grain Products of Atchison, Kans., or a PROLITE brand wheat protein isolate available from Archer Daniels Midland Company of Decatur, Ill.); soy bean protein mixed with lecithin and fiber (such as PFL (named for Protein, Fiber and Lecithin available from Archer Daniels Midland Company); wheat gluten (i.e., such as PROLITE brand wheat gluten available from Archer Daniels Midland Company, Decatur, Ill.); buttermilk solids; milk powders; egg protein; canola protein; canola protein isolates; canola protein concentrates; pea protein; potato protein; corn protein; sesame protein; sunflower protein; cottonseed protein; copra protein; palm kernel protein; safflower protein; linseed protein; peanut protein; lupin protein; oat protein; soy protein; soy protein concentrates; soy protein isolates (i.e., ProFam 781, ProFam 985, or Profam 891 available from Archer Daniels Midland Company, Decatur, Ill.); edible bean proteins; wheat protein concentrate; textured wheat protein powder (i.e., available from Midwest Grain Products, Atchison, Kans.); sweetened composite protein; calcium caseinate; sodium caseinate; textured wheat protein; textured vegetable protein; whey protein concentrate; rice protein concentrate; zein; denatured proteins; oil seed proteins; hydrolyzed proteins; cheese; textured proteins; fish protein; amino acids; peptides; collagen; casein; animal protein; single cell protein; flax protein; flax meal; canola protein; and mixtures of any thereof.

In another embodiment, the compositions of the present disclosure or food composition may comprise a sterol, a tocopherol, any esters thereof, or any combinations thereof. In certain embodiments, the sterols may be plant sterols or vegetable sterols. In yet other embodiments, the tocopherols may be tocopherol, tocopherol acetate, tocopherol succinate or combinations of any thereof.

In other embodiments, the compositions disclosed herein and the processes for manufacturing them d may be used in preparation for drink mixes, instantized hot cereals, cereal, protein powders, energy mixes, supplements, sports nutritional products, oral nutritional supplements, meal replacement beverages, weight loss beverages, puddings mixes, instant pudding, pudding, dry bakery mixes, food replacement products, food products, pharmaceutical products, pharmaceutical excipients, a ready-to-eat cereal and other dry mix applications.

In yet another additional embodiment, the compositions of the present teaching or a food composition including any of these compositions may be produced at a first geographic location and transported or shipped to a second geographic location. For instance, a facility at the first geographic location may be able to produce a product more economically than a facility at the second location due to various factors. The factors may include, inter alia, lower costs of materials, lower costs of energy (i.e., electricity or gas), lower costs of labor (i.e., wages paid to employees), lower costs of environmental controls or effects (i.e., a drought may be present in one location), or any other requirement for production. Further, a certain product may be well suited for production in the first geographic location and desired, but not produced well in the second geographic location. As a non-limiting example, residents of Alaska may desire bananas produced in Central America. Thus, the costs of producing the products in the first geographic location may be less than the costs of producing the products in the second geographic location resulting in the production costs of the product being less in the first geographic location.

In another embodiment of the present disclosure, the cocoa powder that is used may be those disclosed in pending U.S. patent application Ser. No. 11/867,974, filed Oct. 5, 2007 and entitled “Method of Producing High-Brightness Cocoa Powder and Related Compositions,” the disclosure of which is incorporated herein in its entirety by this reference.

The teachings of the present disclosure are further explained by use of the following illustrative EXAMPLES.

### EXAMPLES

The following non-limiting examples are provided to further describe the teachings herein. In various embodiments, dispersible compositions of cocoa were prepared using the teachings of this disclosure. The materials that may be used for preparing the various dispersible compositions descried herein include, but are not limited to: sucrose (obtained from local grocery store); soluble fiber, FIBERSOL-2 brand resistant maltodextrin available from Archer Daniels Midland Company, Decatur, Ill.; lecithin, ULTRALEC P brand lecithin, available from Archer Daniels Midland Company, Decatur, Ill.; DE ZAAN brand cocoa powders D-11-Asol, D-11-A and D-11-S, each of which are available from the Cocoa Division of Archer Daniels Midland Company of Milwaukee, Wis.; sucralose available from Tate and Lyle Company, Decatur Ill.; CardioAid FM Max brand Sterols, available from Archer Daniels Midland Company, Decatur, Ill.; methyl vanillin, available from Rhodia Inc, Cranbury N.J.; calcium carbonate, available from Specialty Minerals, Bethlehem, Pa.; Ace-K, available from Celanese Corporation, Dallas, Tex.; and maltodextrin 15 DE, available from Archer Daniels Midland Company, Decatur, Ill.

### Example 1

A dispersible composition was prepared with the components of Table 1. In this embodiment, twenty three (23) grams of the dispersible composition equals one serving for dispersion into eight (8) fluid ounces of a liquid, such as a beverage.

TABLE 1

| Component | Percent weight |
|---|---|
| Sucrose | 57.00 |
| Soluble fiber, FIBERSOL-2 brand | 25.50 |
| resistant maltodextrin available from | |
| Archer Daniels Midland Company, | |
| Decatur, Illinois | |
| Cocoa powder (D-11-Asol) | 14.50 |
| Calcium Carbonate | 2.60 |
| Methyl Vanillin | 0.40 |
| Sucrose | 57.00 |
| Totals: | 100.00 |

The dispersible composition of this Example was produced with two cocoa powders (e.g., DE ZMN brand cocoa powder D-11-S and D-11-A) each available from the Cocoa Division of Archer Daniels Midland Company of Milwaukee, Wis. The DE ZMN brand cocoa powder D-11-S has the following specifications: the cocoa is processed with alkali; has a standard color and flavor; a fat content of between 10-12%; a pH of between 7.8 and 8.2; a fineness of 99.5% minimum 0.075 mm sieve, water suspension; and a moisture of less than 5%. The DE ZMN brand cocoa powder D-11-A has the following specifications: the cocoa is processed with alkali; has a standard color and flavor; a fat content of between 10-12%; a pH of between 7.0 and 7.4; a fineness of 99.5% minimum 0.075 mm sieve, water suspension; and a moisture of less than 5%.

The nutritional information in Table 2 for the dispersible composition of Table 1 was calculated for the composition itself and as dispersed in 8 ounces of skim milk.

TABLE 2

| | | Value (23 grams |
|---|---|---|
| | Value (23 grams dry | Composition in 8 oz. |
| Nutrient | Composition) | skim milk) |
| Calories (kcal) | 81.10 | 166.85 |
| Calories from Fat (kcal) | 3.95 | 7.92 |
| Fat (g) | 0.44 | 0.88 |
| Saturated fat (g) | 0.22 | 0.49 |
| Trans fatty acid (g) | 0.0 | 0.01 |
| Cholesterol (mg) | 0.0 | 4.41 |
| Sodium (mg) | 0.15 | 126.32 |
| Carbohydrates (g) | 20.48 | 32.36 |
| Dietary fiber (g) | 6.33 | 6.33 |
| Total sugars (g) | 13.41 | 24.19 |
| Protein (g) | 0.66 | 9.02 |
| Vitamin A-IU (IU) | 0.03 | 499.80 |
| Vitamin C (mg) | 0.03 | 2.43 |
| Calcium (mg) | 232.81 | 535.15 |
| Iron (mg) | 0.99 | 1.09 |

### Example 2

A dispersible composition was prepared with the components of Table 3. In this embodiment, twenty (20) grams of the dispersible composition equals one serving for dispersion into eight (8) fluid ounces of a liquid, such as a beverage.

TABLE 3

| Component | Percent weight |
|---|---|
| Sucrose | 66.10 |
| Soluble fiber, FIBERSOL-2 brand | 15.30 |
| resistant maltodextrin available from | |
| Archer Daniels Midland Company, | |
| Decatur, Illinois | |
| Cocoa powder (D-11-A) | 15.77 |
| Calcium carbonate | 1.50 |
| Lecithin, ULTRALEC P brand lecithin, | 0.83 |
| available from Archer Daniels Midland | |
| Company, Decatur, Illinois | |
| Methyl vanillin | 0.50 |
| Totals: | 100.00 |

The dispersible composition of this Example was produced with two cocoa powders (e.g., DE ZAAN brand cocoa powder D-11-S and D-11-A) each available from the Cocoa Division of Archer Daniels Midland Company of Milwaukee, Wis. The DE ZAAN brand cocoa powder D-11-S has the following specifications: the cocoa is processed with alkali; has a standard color and flavor; a fat content of between 10-12%; a pH of between 7.8 and 8.2; a fineness of 99.5% minimum 0.075 mm sieve, water suspension; and a moisture of less than 5%. The DE ZMN brand cocoa powder D-11-A has the following specifications: the cocoa is processed with alkali; has a standard color and flavor; a fat content of between 10-12%; a pH of between 7.0 and 7.4; a fineness of 99.5% minimum 0.075 mm sieve, water suspension; and a moisture of less than 5%.

The nutritional information in Table 4 for the dispersible composition of Table 3 was calculated for the composition itself and as dispersed in 8 ounces of skim milk.

TABLE 4

| | | Value (20 grams |
|---|---|---|
| | Value (20 grams dry | Composition in 8 oz. |
| Nutrient | Composition) | skim milk) |
| Calories (kcal) | 70.81 | 156.56 |
| Calories from Fat (kcal) | 3.91 | 7.88 |
| Fat (g) | 0.43 | 0.88 |
| Saturated fat (g) | 0.21 | 0.49 |
| Trans fatty acid (g) | 0.0 | 0.01 |
| Cholesterol (mg) | 0.0 | 4.41 |
| Sodium (mg) | 0.10 | 126.27 |
| Carbohydrates (g) | 17.91 | 29.79 |
| Dietary fiber (g) | 3.79 | 3.79 |
| Total sugars (g) | 13.38 | 24.16 |
| Protein (g) | 0.66 | 9.01 |
| Vitamin A-IU (IU) | 0.03 | 499.80 |
| Vitamin C (mg) | 0.03 | 2.43 |
| Calcium (mg) | 118.57 | 420.88 |
| Iron (mg) | 0.89 | 0.99 |

### Example 3

Three dispersible compositions were prepared with the components of Table 5. In formulation A, twenty three (23) grams of the dispersible composition equals one serving for dispersion into eight (8) fluid ounces of a liquid, such as a beverage, and in formulations B and C, twenty grams (20) of the dispersible composition equals one serving for dispersion into eight (8) fluid ounces of a liquid, such as a beverage.

TABLE 5

| | Percent weight | Percent weight | Percent weight |
|---|---|---|---|
| Component | Formulation A | Formulation B | Formulation C |
| Sucrose | 57.00 | 66.10 | 66.10 |
| Soluble fiber, | 25.50 | 15.30 | 15.30 |
| FIBERSOL-2 | | | |
| brand | | | |
| Cocoa powder (D- | 14.50 | 16.60 | 18.10 |
| 11-A) | | | |
| Calcium carbonate | 2.60 | 1.50 | 0.00 |
| Methyl vanillin | 0.40 | 0.50 | 0.50 |
| Totals: | 100.00 | 100.00 | 100.00 |

The dispersible compositions of this Example were produced with DE ZMN brand cocoa powder D-11-Asol available from the Cocoa Division of Archer Daniels Midland Company of Milwaukee, Wis. The DE ZAAN brand cocoa powder D-11-Asol has the following specifications: the cocoa is processed with alkali; has a standard color and flavor; a fat content of between 10-12% (excluding lecithin); a pH of between 7.0 and 7.4; a fineness of 99.5% minimum 0.075 mm sieve, water suspension; a moisture of less than 5% and a lecithin content of about 5% soy lecithin.

### Example 4

In this embodiment, the components and amounts of Table 1 were used to produce an agglomerated composition. The sucrose, FIBERSOL-2, cocoa powder, calcium carbonate and methyl vanillin were pre-weighed. The methyl vanillin was placed into the calcium carbonate and bag blended. The methyl vanillin/calcium carbonate blend was placed into the cocoa powder and bag blended. The sucrose, FIBERSOL-2 and cocoa powder/methyl vanillin/calcium carbonate blend were placed into a V-shell blender (i.e., a rotating blender) and blended for about 15 minutes, thus forming a homogenous blend of the sucrose, FIBERSOL-2, cocoa powder, calcium carbonate and methyl vanillin. The lecithin was weighed and placed in an appropriate amount of water to form a 5% weight/weight solution of the lecithin in the water and was used as the agglomerating agent.

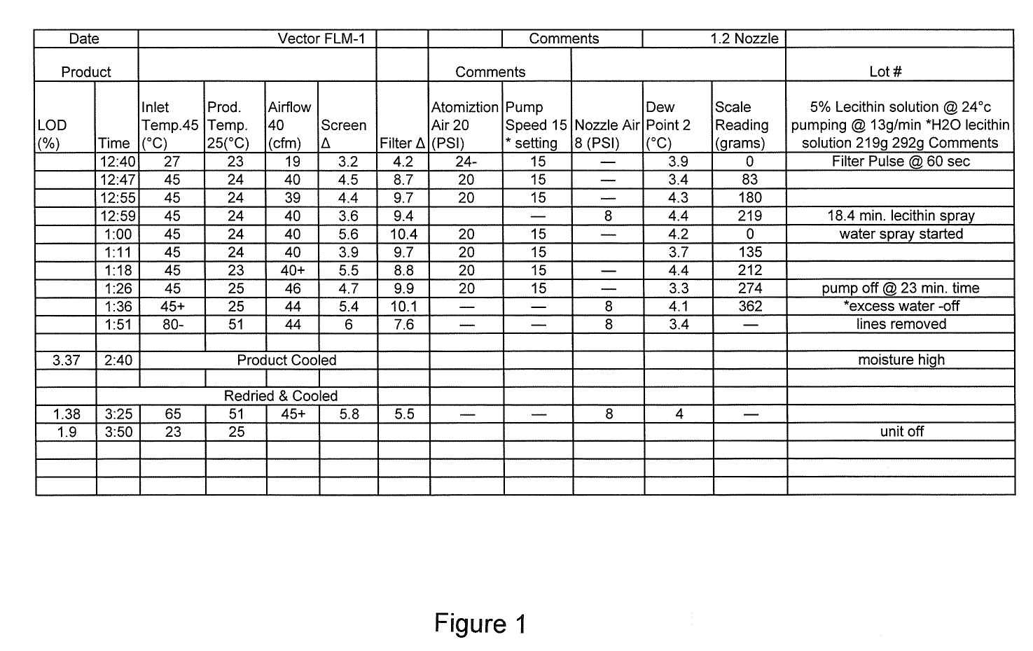

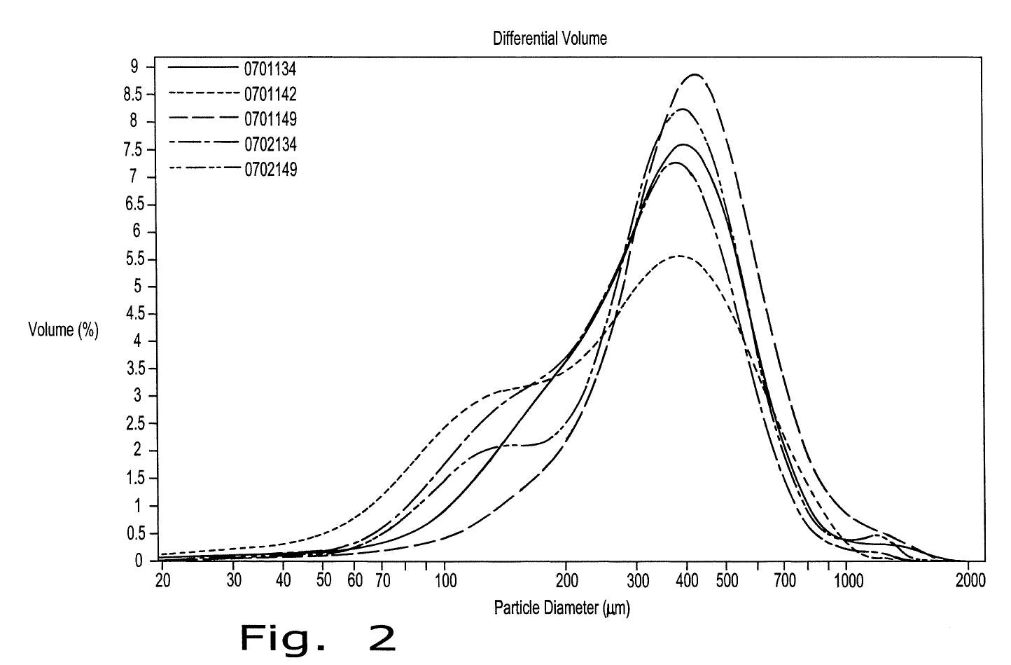

The homogenous blend of the particles was charged into a fluid bed agglomerator (i.e., granulator) and agglomerated with the 5% lecithin in the water (i.e., the agglomerating agent) using the run conditions of FIG. 1. The agglomerates produced in this embodiment have the particle size distribution corresponding to the number 01142 of the graph and volume statistics depicted in FIG. 2. In another embodiment, an amount of the digestion resistant soluble fiber (e.g., the FIBERSOL-2) may be mixed with water and used as the agglomerating agent.

### Example 5

In this embodiment, the components and amounts of Table 3 were used to produce an agglomerated composition. The sucrose, FIBERSOL-2, cocoa powder, calcium carbonate and methyl vanillin were pre-weighed. The methyl vanillin was placed into the calcium carbonate and bag blended. The methyl vanillin/calcium carbonate blend was placed into the cocoa powder and bag blended. The sucrose, FIBERSOL-2 and cocoa powder/methyl vanillin/calcium carbonate blend were placed into a V-shell blender (i.e., a rotating blender) and blended for about 15 minutes, thus forming a homogenous blend of the sucrose, FIBERSOL-2, cocoa powder, calcium carbonate and methyl vanillin.

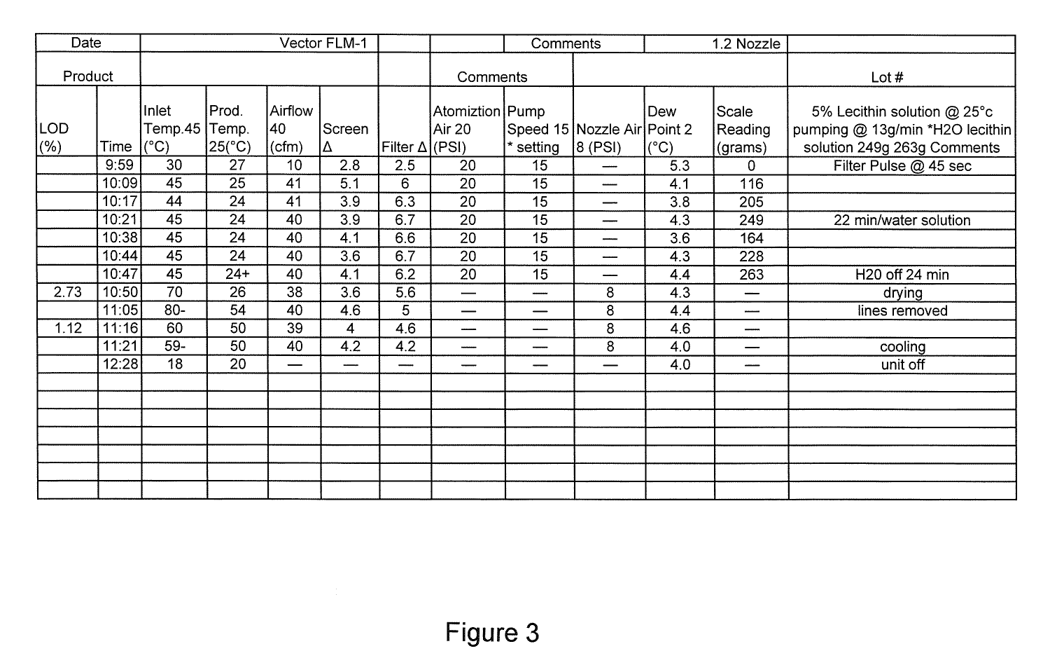

The homogenous blend of the particles was charged into a fluid bed agglomerator (i.e., granulator) and agglomerated with the 5% lecithin in 95% water using the run conditions of FIG. 3. The agglomerates produced in this embodiment have the particle size distribution corresponding to the number 02149 of the graph and volume statistics depicted in FIG. 2. The data corresponding to FIG. 2 is presented in the following table.

FIG. 2 table.

| | | Mean | S.D. | Variance | | | |
|---|---|---|---|---|---|---|---|
| | Amount (%) | μm | μm | μm² | d10 μm | d50 μm | d90 μm |
| 0701134 CCO | 100 | 367 | 208 | 43167 | 142 | 343 | 602 |
| 0701142 | 100 | 314 | 200 | 39929 | 88.8 | 283 | 592 |
| CCOFBRSL | | | | | | | |
| 0701149 CCA | 100 | 430 | 217 | 47199 | 193 | 401 | 686 |
| 0702134 | 100 | 326 | 179 | 91869 | 116 | 309 | 549 |
| CCOFBRSL | | | | | | | |
| 0702149 CCA | 100 | 364 | 197 | 38739 | 124 | 349 | 592 |
| (Average) | 100 | 360 | 200 | 40181 | 133 | 337 | 604 |
| (C.V.) | 0.0% | 12.6% | 7.2% | 14.2% | 29.1% | 13.2% | 8.2% |
| (Maximum) | 100 | 430 | 217 | 47199 | 193 | 401 | 686 |
| (Minimum) | 100 | 314 | 179 | 31869 | 88.8 | 283 | 549 |

### Example 6

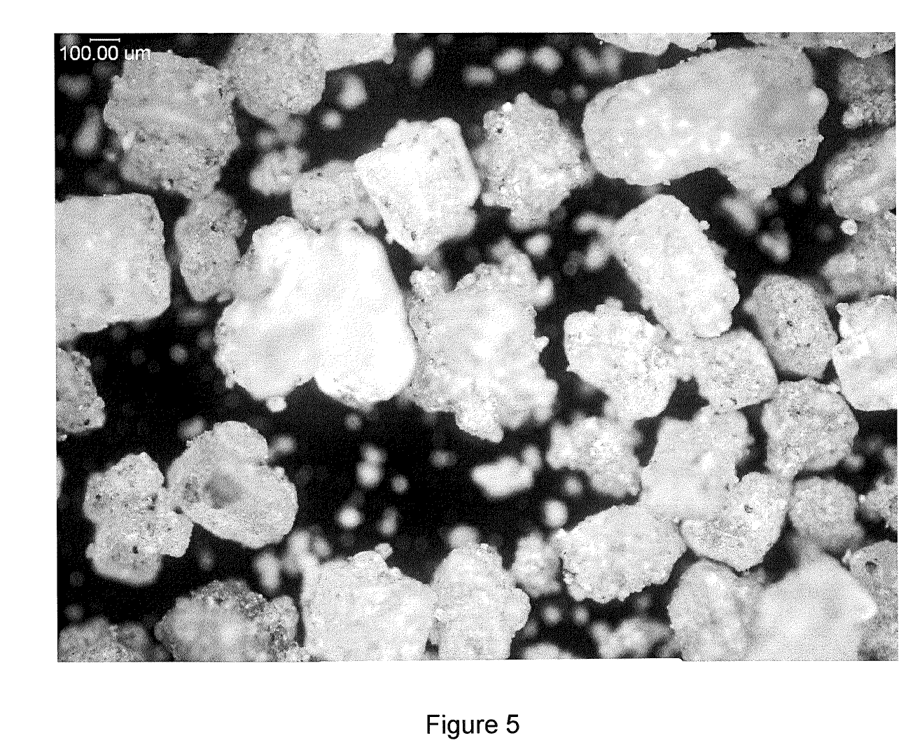

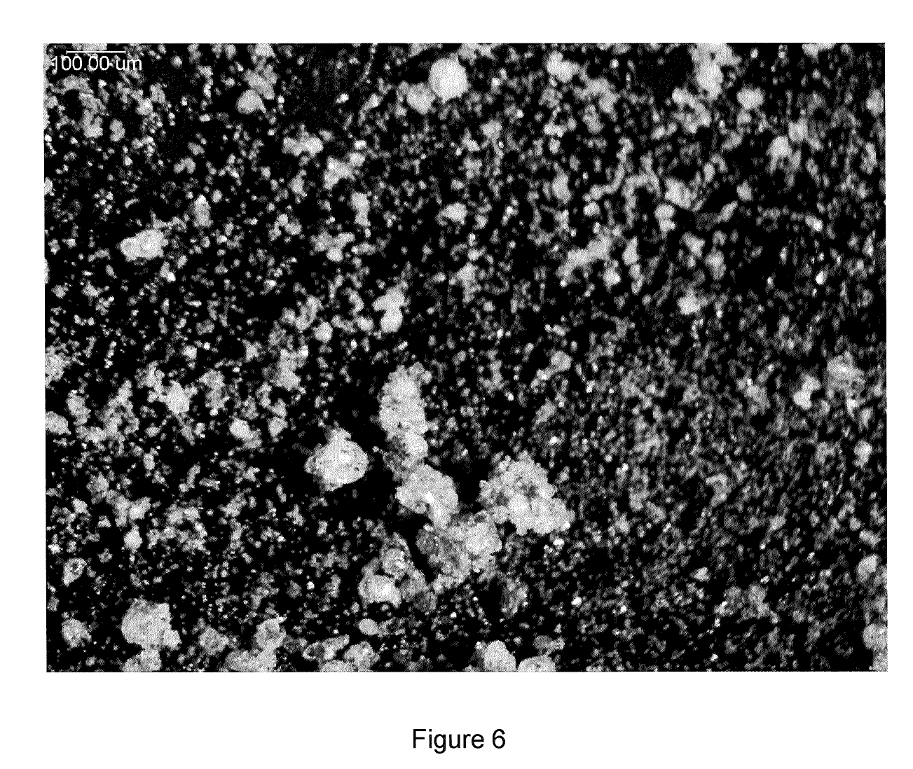

In this example, agglomerates of a plurality of granules of sucrose, FIBERSOL-2, cocoa powder, and methyl vanillin were produced using formulation C of Example 3 by reducing a surface area of the plurality of the granules using the processes described herein. The surface area was reduced by agglomerating the plurality of the granules with water in a fluid bed agglomerator as described herein. FIG. 5 is a picture of the granules at a magnification of 50× before the agglomeration, and FIG. 6 is a picture of the agglomerates formed after the agglomeration process at 50×.

### Example 7

Two dispersible compositions were prepared with the components of Tables 6 and 7. In formulation D, eighteen (18) grams of the dispersible composition equals one serving for dispersion into eight (8) fluid ounces of a liquid, such as a beverage.I In formulations E and F, twenty three grams (23) of the dispersible composition equals one serving for dispersion into eight (8) fluid ounces of a liquid, such as a beverage.

TABLE 6
(Formulation D).

| Material Description | % w/w |
|---|---|
| Soluble fiber, FIBERSOL-2 brand | 37.00 |
| resistant maltodextrin available | |
| from Archer Daniels Midland | |
| Company, Decatur, Illinois | |
| Cocoa (De Zaan D-11-S) | 32.00 |
| Maltodextrin (15DE) | 26.28 |
| Calcium Carbonate | 2.60 |
| Lecithin, ULTRALEC P brand lecithin, available | 1.60 |
| from Archer Daniels Midland Company, | |
| Decatur, Illinois | |
| Methyl Vanillin | 0.40 |
| Ace-K | 0.08 |
| Sucralose | 0.04 |
| Totals | 100.00 |

TABLE 7
(Formulation E).

| Material Description | % w/w |
|---|---|
| Sucrose | 40.91 |
| Fibersol-2 | 25.50 |
| Cocoa (De Zaan D-11-A) | 29.10 |
| Calcium Carbonate | 2.60 |
| Lecithin, ULTRALEC P brand lecithin, | 1.49 |
| available from Archer Daniels Midland | |
| Company, Decatur, Illinois | |
| Methyl Vanillin | 0.40 |
| Totals | 100.00 |

TABLE 8
(Formulation F)

| Material | %, w/w |
|---|---|
| Soluble fiber, FIBERSOL-2 brand resistant | 54.43 |
| maltodextrin available from Archer Daniels | |
| Midland Company, Decatur, Illinois | |
| Cocoa powder (D-11-S) | 40 |
| Tri-Calcium Phosphate | 3 |
| Lecithin, ULTRALEC P brand lecithin, | 2.09 |
| available from Archer Daniels Midland | |
| Company, Decatur, Illinois | |
| Methyl Vanillin | 0.4 |
| Sucralose | 0.083 |
| Totals | 100 |

The dispersible compositions of this Example were produced with DE ZAAN brand cocoa powder D-11-A available from the Cocoa Division of Archer Daniels Midland Company of Milwaukee, Wis. The DE ZAAN brand cocoa powder D-11-A has the following specifications: the cocoa is processed with alkali; has a standard color and flavor; a fat content of between 10-12% (excluding lecithin); a pH of between 7.0 and 7.4; a fineness of 99.5% minimum 0.075 mm sieve, water suspension; a moisture of less than 5% and a lecithin content of about 5% soy lecithin.

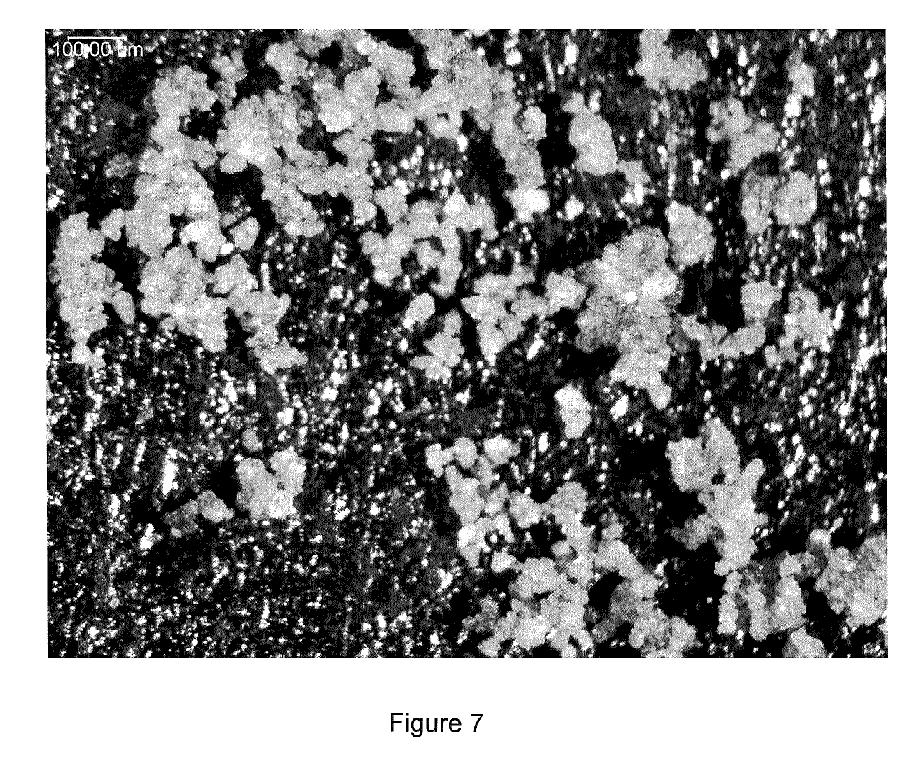

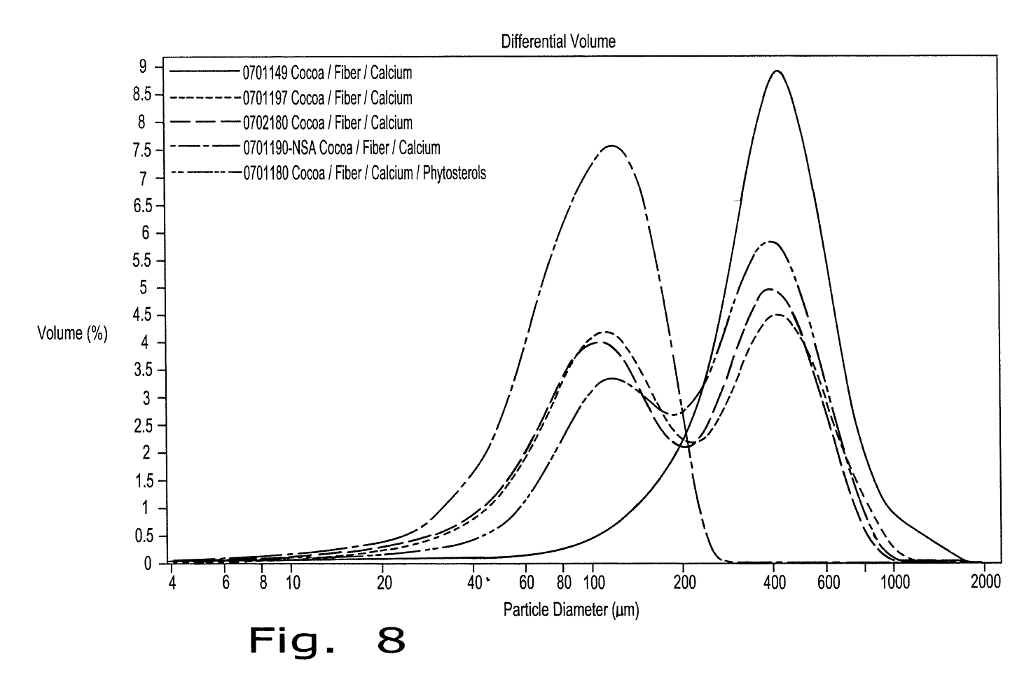

The plurality of the granules were agglomerlated with water in a fluid bed agglomerator as described herein. FIG. 6 is a picture of the granules at a magnification of 50× before the agglomeration and FIG. 7 is a picture of the agglomerates formed after the agglomeration process at 50×. The agglomerates produced in this embodiment have the particle size distribution corresponding to the number 0701190 of the graph and volume statistics depicted in FIG. 8. The data corresponding to FIG. 8 is presented in the following table.

FIG. 8 table.

| | Amount | Mean | S.D. | Variance | d10 | d50 | d90 |
|---|---|---|---|---|---|---|---|
| | (%) | μm | μm | μm² | μm | μm | μm |
| 0701149 CCA | 100 | 430 | 217 | 47199 | 193 | 401 | 686 |
| 0701197-447 | 100 | 264 | 207 | 42650 | 61.2 | 186 | 564 |
| 0702180 | 100 | 251 | 188 | 35401 | 56.8 | 189 | 525 |
| CCO AGG | | | | | | | |
| 0701190 NSA AGG | 100 | 103 | 47.9 | 2294 | 43.5 | 99.5 | 170 |
| 0701180 | 100 | 293 | 190 | 35965 | 77.5 | 270 | 558 |
| CCO AGG | | | | | | | |
| (Average) | 100 | 268 | 170 | 32702 | 86.4 | 229 | 501 |
| (C.V.) | 0.0% | 43.4% | 40.8% | 54.1% | 70.3% | 49.6% | 38.9% |
| (Maximum) | 100 | 430 | 217 | 47199 | 193 | 401 | 686 |
| (Minimum) | 100 | 103 | 47.9 | 2294 | 43.5 | 99.5 | 170 |

The nutritional information presented in Table 9 for the dispersible composition of Table 6 was calculated for the composition itself.

TABLE 9

| | | Value |
|---|---|---|
| | | present in |
| | | 18 g of |
| Nutrient | | blend |
| Calories | | 56.3 |
| Calories from fat | | 7.1 |
| Protein (g) | | 1.2 |
| Carbohydrates (g) | | 13.8 |
| | Dietary fiber | 7.8 |
| | (g) | |
| | Sugars (g) | 0.7 |
| Fat (g) | | 0.8 |
| | Saturated | 0.4 |
| | Fat (g) | |
| | Trans Fat | 0 |
| | (g) | |
| | Cholesterol | 0 |
| | (mg) | |
| Vitamin A (IU) | | 0.07 |
| Vitamin C (mg) | | 0.06 |
| Calcium (mg) | | 236.2 |
| Iron (mg) | | 1.9 |
| Sodium (mg) | | 0.2 |

The nutritional information presented in Table 10 for the dispersible composition of Table 7 was calculated for the composition itself.

TABLE 10

| | | Value present in 23 g |
|---|---|---|
| Nutrient | | of blend |
| Calories | | 75.2 |
| Calories from fat | | 8.3 |
| Protein (g) | | 1.4 |
| Carbohydrates (g) | | 18.7 |
| | Dietary fiber | 7.5 |
| | (g) | |
| | Sugars (g) | 9.7 |
| Fat (g) | | 0.9 |
| | Saturated | 0.5 |
| | Fat (g) | |
| | Trans Fat | 0 |
| | (g) | |
| | Cholesterol | 0 |
| | (mg) | |
| Vitamin A (IU) | | 0.06 |
| Vitamin C (mg) | | 0.03 |
| Calcium (mg) | | 216.5 |
| Iron (mg) | | 1.6 |
| Sodium (mg) | | 2.5 |

### Example 8

A sterol based dispersible composition was prepared with the components of Table 11. In formulation G, twenty three (23) grams of the dispersible composition equals one serving for dispersion into eight (8) fluid ounces of a liquid, such as a beverage.

TABLE 11
(Formulation G)

| Material Description | % w/w |
|---|---|
| Sucrose | 52.5 |
| Soluble fiber, FIBERSOL-2 brand resistant | 25.5 |
| maltodextrin available from Archer Daniels | |
| Midland Company, Decatur, Illinois | |
| Cocoa (D-11-A) | 13.77 |
| Calcium Carbonate | 2.6 |
| CardioAid FM MAX | 4.5 |
| Lecithin, ULTRALEC P brand lecithin, | 0.73 |
| available from Archer Daniels Midland | |
| Company, Decatur, Illinois | |
| Methyl Vanillin | 0.4 |
| Totals | 100 |

The agglomerates produced in this embodiment have the particle size distribution corresponding to the number 0701180 of the graph and volume statistics depicted in FIG. 9.

### Example 9

A sterol ester based dispersible composition is prepared with the components of Table 12. In formulation H, twenty three (23) grams of the dispersible composition equals one serving for dispersion into eight (8) fluid ounces of a liquid, such as a beverage.

TABLE 12
(Formulation H)

| Material Description | % w/w |
|---|---|
| Sucrose | 52.5 |
| Soluble fiber, FIBERSOL-2 brand resistant | 25.5 |
| maltodextrin available from Archer Daniels | |
| Midland Company, Decatur, Illinois | |
| Cocoa (D-11-A) | 13.77 |
| Calcium Carbonate | 2.6 |
| Sunflower Sterol Esters | 4.5 |
| Lecithin, ULTRALEC P brand lecithin, | 0.73 |
| available from Archer Daniels Midland | |
| Company, Decatur, Illinois | |
| Methyl Vanillin | 0.4 |
| Totals | 100 |

### Example 10

A tocopherol (acetate) based dispersible composition is prepared with the components of Table 13. In formulation 1, twenty three (23) grams of the dispersible composition equals one serving for dispersion into eight (8) fluid ounces of a liquid, such as a beverage.

TABLE 13
(Formulation I)

| Material Description | % w/w |
|---|---|
| Sucrose | 52.5 |
| Soluble fiber, FIBERSOL-2 brand resistant | 29.935 |
| maltodextrin available from Archer Daniels | |
| Midland Company, Decatur, Illinois | |
| Cocoa (D-11-A) | 13.77 |
| Calcium Carbonate | 2.6 |
| Tocopherol (acetate) | 0.065 |
| Lecithin, ULTRALEC P brand lecithin, | 0.73 |
| available from Archer Daniels Midland | |
| Company, Decatur, Illinois | |
| Methyl Vanillin | 0.4 |
| Totals | 100 |

### Example 11

A tocopherol (succinate) based dispersible composition is prepared with the components of Table 14. In formulation J, twenty three (23) grams of the dispersible composition equals one serving for dispersion into eight (8) fluid ounces of a liquid, such as a beverage.

TABLE 14
(Formulation J)

| Material Description | % w/w |
|---|---|
| Sucrose | 52.5 |
| Soluble fiber, FIBERSOL-2 brand resistant | 29.848 |
| maltodextrin available from Archer Daniels | |
| Midland Company, Decatur, Illinois | |
| Cocoa (D-11-A) | 13.77 |
| Calcium Carbonate | 2.6 |
| Tocopherol (succinate) | 0.152 |
| Lecithin, ULTRALEC P brand lecithin, | 0.73 |
| available from Archer Daniels Midland | |
| Company, Decatur, Illinois | |
| Methyl Vanillin | 0.4 |
| Totals | 100 |

The present teaching has been described with reference to certain exemplary embodiments, dispersible compositions and uses thereof. However, it will be recognized by those of ordinary skill in the art that various substitutions, modifications or combinations of any of the exemplary embodiments may be made without departing from the spirit and scope of the teaching. Thus, this teaching is not limited by the description of the exemplary embodiments, but rather by the appended claims as originally filed.

1. A composition, comprising:
a sweetener;
a digestion resistant soluble fiber;
a cocoa powder; and
a dispersing agent;
wherein the sweetener, the digestion resistant soluble fiber, the cocoa powder and the dispersing agent are present in the composition in such amounts such that the composition disperses in liquid.

2. The composition of claim 1, further comprising a calcium containing compound selected from the group consisting of calcium citrate, calcium lactate, calcium carbonate, calcium phosphate and combinations of any thereof.

3-4. (canceled)

5. The composition of claim 1, further comprising a flavoring agent selected from the group consisting of a vanilla flavor, banana flavor, strawberry flavor and any combination thereof.

6. The composition of claim 1, wherein the dispersing agent is selected from the group consisting of a standard lecithin, a purified lecithin, a complexed lecithin, a modified lecithin, a deoiled lecithin and combinations of any thereof.

7. The composition of claim 1, further comprising a protein.

8. The composition of claim 1, wherein the sweetener is selected from the group consisting of sucrose, fructose, maltitol, isomalt, lactitol, xylitol, erythritol, sorbitol, mannitol, tagatose, acesulfame K, sucralose, saccharin, cyclamates, aspartame, alitame and any combination thereof.

9. The composition of claim 1, wherein the digestion resistant soluble fiber is selected from the group consisting of a resistant maltodextrin, a dextrin, a fructan, a fructose oligosaccharide, inulin, oligofructose, maltodextrin, polydextrose and any combinations thereof.

10. The composition of claim 1, further comprising a sterol, a tocopherol, and any esters thereof or any combinations thereof.

11. A composition comprising:
an agglomerate of at least two particles selected from the group consisting of a sweetener particle, a digestion resistant soluble fiber particle, a cocoa powder particle, and combinations of any thereof; and
a dispersing agent associated with the agglomerate.

12. (canceled)

13. The composition of claim 11, further comprising a calcium containing particle.

14. (canceled)

15. The composition of claim 11, further comprising a flavoring agent selected from the group consisting of a vanilla flavor, banana flavor, strawberry flavor and any combination thereof.

16. The composition of claim 11, wherein the dispersing agent is selected from the group consisting of a standard lecithin, a purified lecithin, a complexed lecithin, a modified lecithin, a deoiled lecithin and combinations of any thereof.

17. The composition of claim 11, further comprising a protein.

18. The composition of claim 11, wherein the sweetener is selected from the group consisting of sucrose, fructose, maltitol, isomalt, lactitol, xylitol, erythritol, sorbitol, mannitol, tagatose, acesulfame K, sucralose, saccharin, cyclamates, aspartame, alitame and any combination thereof.

19. The composition of claim 11, wherein the digestion resistant soluble fiber is selected from the group consisting of a resistant maltodextrin, a dextrin, a fructan, a fructose oligosaccharide, inulin, oligofructose, maltodextrin, polydextrose and any combinations thereof.

20. The composition of claim 11, further comprising a sterol, a tocopherol, esters of any thereof or any combinations thereof.

21-34. (canceled)

35. A composition comprising:
a sweetener particle;
a digestion resistant soluble fiber particle;
a cocoa powder particle;
a calcium containing particle;
an agglomerate comprising at least two particles selected from the group consisting of the sweetener particle, the digestion resistant soluble fiber particle, the cocoa powder particle, the calcium containing particle and combinations of any thereof; and
a deoiled lecithin associated with the sweetener particle, the digestion resistant soluble fiber particle, the cocoa powder particle, the calcium containing particle, the agglomerate, or combinations of any thereof.

36. The composition of claim 35, wherein a table spoon of the product comprises at least 2.5 grams of dietary fiber.

37. The composition of claim 35, wherein a table spoon of the product comprises at least 100 milligrams of calcium.

38. The product of claim 35, where in a table spoon of the product further comprises a sterol, a tocopherol, esters of any thereof or any combinations thereof.

39-41. (canceled)
